(19) United States
(12) Patent Application Publication
(10) Pub. No.: US 2003/0042075 A1
(43) Pub. Date: Mar. 6, 2003

(54) Portable hunting and fishing stand

(76) Inventor: Douglas M. Bench, Houston, TX (US)

Correspondence Address: FULBRIGHT & JAWORSKI, LLP, 1301 MCKINNEY, SUITE 5100, HOUSTON, TX, 77010-3095, US

(21) Appl. No.: 09/946,221

(22) Filed: Sep. 5, 2001

(51) Int. Cl. A47C 9/00; E06C 7/16

(52) U.S. Cl. 182/115

(57) ABSTRACT

A portable hunting and fishing stand assembled from lightweight components. The legs of the stand are connected to a central-bracing mechanism. The bracing mechanism provides strong support for persons using the stand. The central-bracing mechanism includes braces interconnected between the legs of the stand and a central slide. The slide travels along a portion of a slide shaft that is connected to the bottom-side of the stand platform, thus allowing the stand legs to move in concert with one another. Additionally, the stand features a unique foot pad for use in sand, with fluid passages drilled through the outer surface of the foot pad and a concave bottom cavity for use in water with a sandy bottom.

### BACKGROUND OF THE INVENTION

1. Field of the Invention

The present invention relates generally to a stand for supporting a person, and more particularly, a portable stand for supporting a person during hunting or fishing and water-related activities.

2. Background of the Invention

Existing hunting stands on the market today are quite heavy, and require some form of assistance to get them to the hunting location in the field or woods. Vehicles of some kind or manpower is often needed to get the hunting stand to a perfect hunting location deep in the woods. This inventive hunting and fishing stand overcomes this problem as it provides a light-weight sturdy portable stand that can be carried in one piece. Another advantage of the inventive device is that a hunter can move the stand from one location to another hunting location during the hunting period without the assistance of another person. Sometimes a hunting area can become fouled and a new position would be advantageous to the hunter. The inventive stand allows the hunter to be more independent with his hunting time spent in the field, and gains an advantage in producing game using the invention.

Additionally, a need exists for a sturdy light-weight fishing stand that can be easily carried and set up in the water. Other water-based stands exist, but are either, too difficult to utilize or do not provide necessary rigid support. Additionally, none of the water-based stands are designed for the combination-purpose of hunting and water-use.

### BRIEF SUMMARY OF THE INVENTION

The present invention is directed to a portable hunting and fishing stand. The invention is a portable device that allows a singular person to can carry from a beach or land area into a body of water such as an ocean or bay, or carried and used on land such as in a wooded-area or fields for hunting game. The inventive stand includes a unique brace and slide system that provides a sturdy base and provides for easy opening and closing of the legs. Three legs of the stand (although more legs may be used) are connected to a central-bracing mechanism. The bracing mechanism provides strong support for persons using the stand. The central-bracing mechanism includes braces interconnected between the legs of the stand and a central slide. The slide travels along a portion of a slide shaft that is connected to the bottom-side of the stand platform, thus allowing the stand legs to move in concert with one another. Additionally, the stand features a unique foot pad for use in sand, with fluid passages drilled through the outer surface of the foot pad and a concave bottom cavity. Furthermore, the stand may utilize another set of braces connect to another part of the legs and another slide connected to the slide shaft.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a side-view of one embodiment of the stand;

FIG. 2 is a side-view of an alternative embodiment of the stand;

FIG. 3 is a front-top view of surf stand;

FIG. 4 is a detail-view of the apparatus foot pad; and

FIG. 5 is a side-view of an alternative embodiment of the stand.

### DETAILED DESCRIPTION OF THE INVENTION

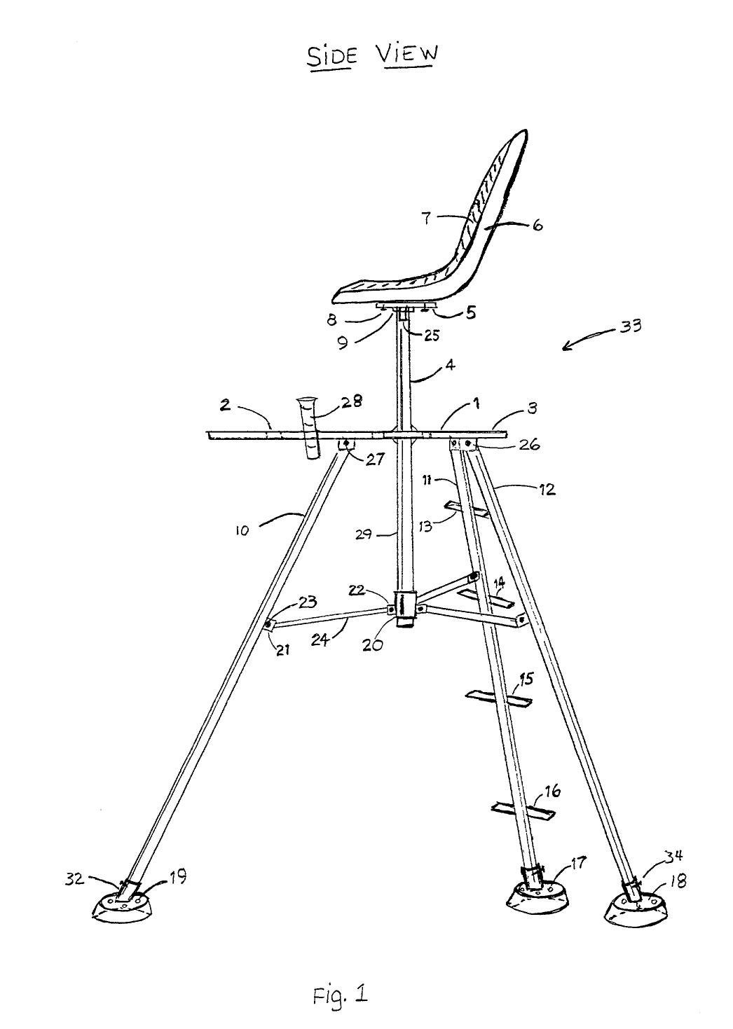

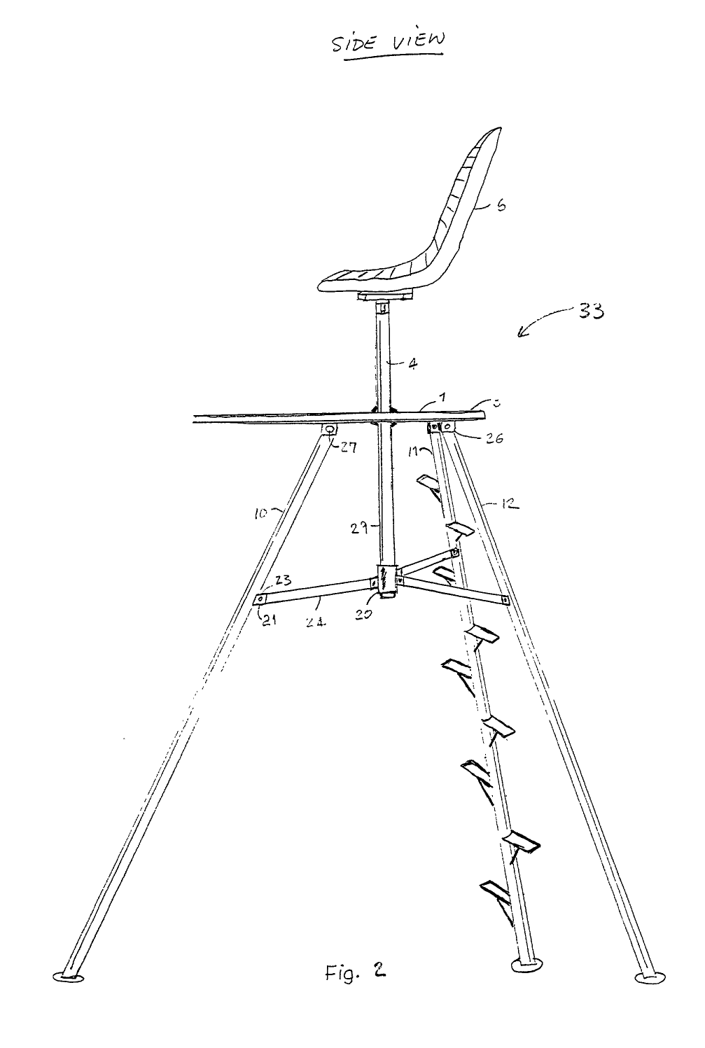

Referring to FIGS. 1-3, one embodiment of the inventive portable hunting and fishing (33) is depicted with its component parts. The component pieces are preferably made of light-weight materials, such as aluminum, carbon-fiber composites, or light sturdy plastics and may be connected together through appropriate means such as welding, fastening, etc.

A platform (3) is attached to a seat shaft (4) and is connected to a top-side of the platform (3). A seat (6) (shown with a cushion (7)) is connected to the seat shaft (4). A seat plate (5) and swivel shaft (25) may be connected to the seat (6) and the seat shaft (4) to allow the seat (6) to pivot or swivel. A nylon bushing (9) over seat shaft (4) may be used to assist in the pivoting of the seat (6). Bolts (8) may be used to attach the seat plate (5) to seat (6).

Rod holder holes (2) are drilled through the platform (3) at several locations as needed for use with rod holders (28). Extra “bolt-on” devices may be added to the platform, such as cup holders, cooler box, tackle box, bow and arrow-holder, gun-rack/holder, tack box, etc.

Platform leg brackets (26) are affixed to the bottom-side of the platform (3). The leg brackets (26) may be connected to the legs (10, 11 and 12) with pivot bolts (27). The leg brackets described herein may be connected with alternative connection means that will allow the connected parts (such as the legs and braces) to hingedly move or swing with the brackets. The legs (10, 11 and 12) are drilled through at the top end of the legs (10, 11 and 12) when using pivot bolts to connect the legs to the platform leg brackets (26). A slide shaft (29) is connected to the bottom-side of the platform (3). The slide shaft (29) has brackets (22) that allow leg braces (24) to be connected to the slide shaft brackets (22) and the leg brace brackets (21) with a pivot bolt. Steps (13, 14, 15 and 16) are connected to one or more of the legs (10, 11 and 12) to allow the user of the stand (33) to securely climb to the top of the platform (3).

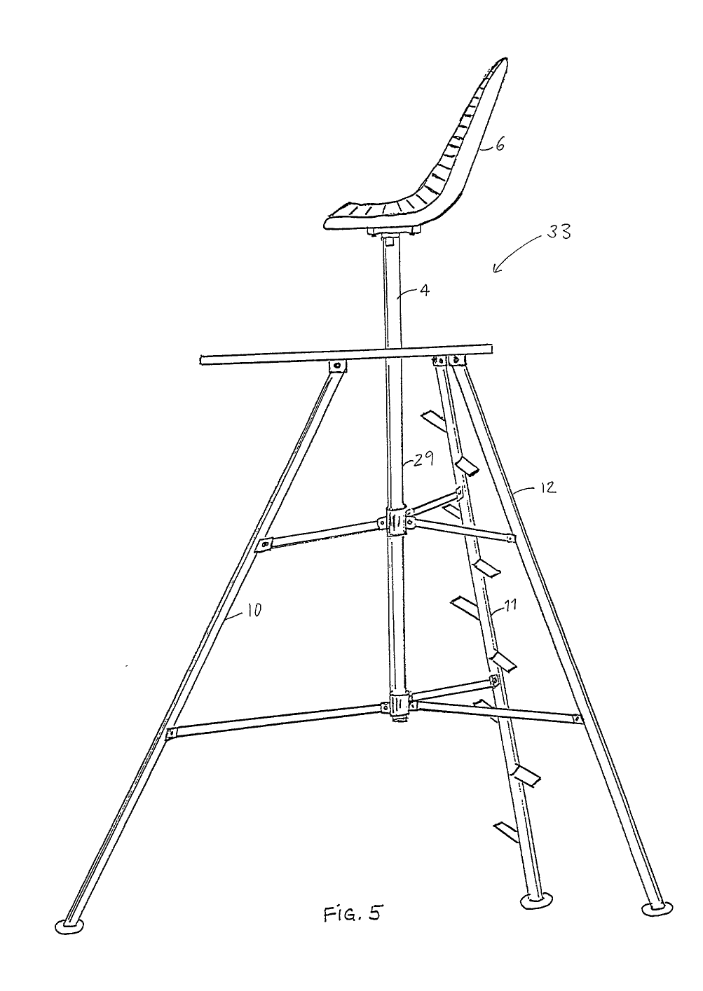

Pulling the legs outward will cause the slide (20) to descend down the slide shaft (29). Similarly, pushing the legs inward will cause the slide (20) to ascend up the slide shaft (29). The legs (10), (11) and (12) may be fully extended and the slide (20) will lock into position at the end of the slide shaft (29). Additionally, a friction knob or lock may be utilized with the slide (20) to allow use of the stand (33) with the legs not fully extended or to aid in carrying the stand (33) so that the legs will not move. See also FIG. 5 depicting an alternative embodiment of the stand with multiple central bracing mechanisms.

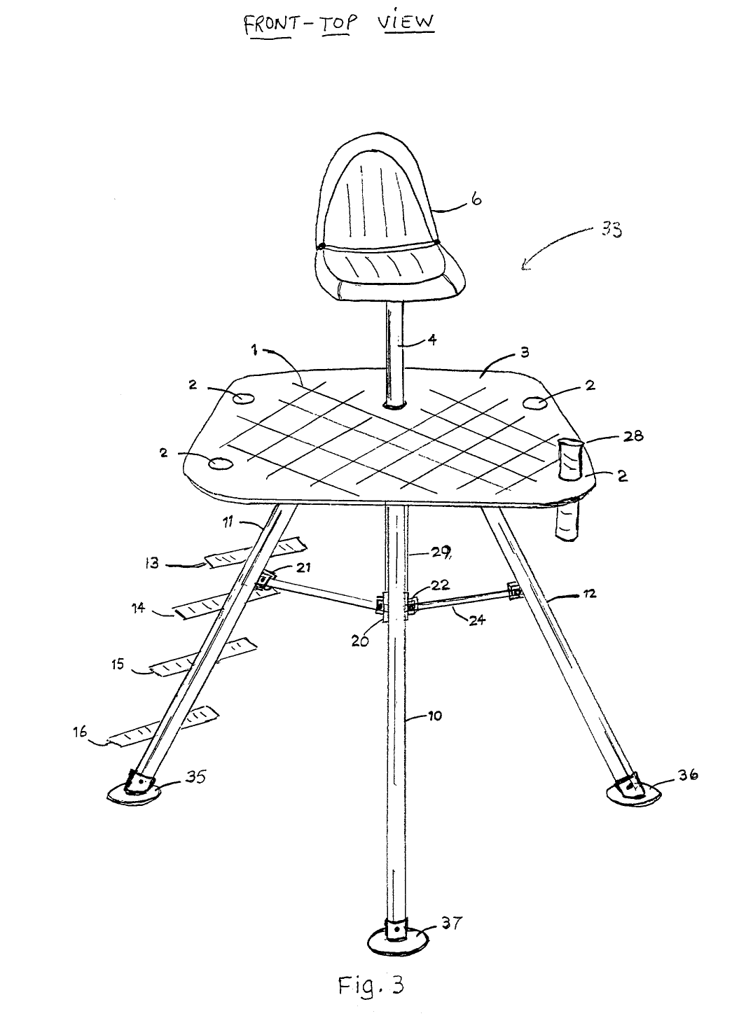

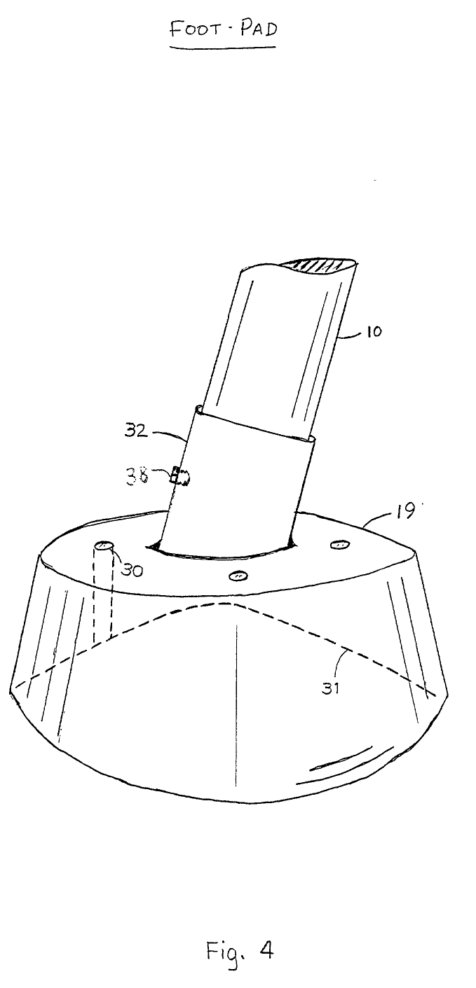

Foot pads (17, 18 and 19) and (35, 36 and 37) may be connected to the legs allowing for the interchange of specific foot pads for a particular use or activity. Referring to FIG. 4, a detail-view of an inventive footpad is shown that may be used with the hunting and fishing stand (33), in particular most useful for water related activities. The foot pad (19) has a concave bottom (31) and drill holes (30) providing anchoring to the ocean floor by reacting to downward pressure of the weight of tripod and occupant pressing sand into designed concave area (31) of foot forcing water out bleed off holes (30) and filling foot with compacted sand creating a suction to ocean floor. Additionally, other foot pads may be used, for example the foot plate (37) depicted in FIG. 3.

The foot pad (19) has a mounting sleeve (32) for the receipt of the bottom of a leg. The mounting sleeve may be secured to the leg, for example by a screw (38) that penetrates the leg. The foot pad (19) when actuated by downward pressure creates an anchoring effect. As the foot pad (19) becomes dislodged from the ocean floor, the sand is pulled downward by gravity creating a vacuum in the upper chamber of the foot. Water then rushes into the foot chamber in order to equalize the vacuum. With the density of water trying to fill the vacuum area within the foot chamber there is ample suction time for the tripod to withstand the wave action of the surf.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A portable hunting and fishing stand comprising:
a platform having a top side and bottom side;
a seat shaft connected to said top side of said platform;
a seat pivotally connected to said seat shaft;
at least three legs having a top end and bottom end, said top end of said legs being hingedly attached to said bottom side of said platform;
a slide shaft connected to said bottom side of said platform, said slide shaft having a slide which is moveably slideable along at least a portion of said slide shaft; and
at least three leg braces wherein each leg braces is hingedly attached to said bottom side of said platform and said at least three legs.

2. The portable hunting and fishing stand of claim 1, further comprising one or more fishing holders detachably insertable into said platform.

3. The portable hunting and fishing stand of claim 1, wherein one or more of the at least three legs comprises one or more affixed foot steps.

4. The portable hunting and fishing stand of claim 1, further comprising a seat plate connected between said seat and said seat stand allowing pivotal movement of said seat.

5. The portable hunting and fishing stand of claim 1, further comprising one or more foot pads detachably connected to said bottom end of said at least three legs.

6. The portable hunting and fishing stand of claim 1, comprising foot pads having one or more fluid passage ways connecting an outer surface of said foot pads to a concave bottom cavity.

7. A portable hunting and fishing stand comprising:
a platform having a top side and bottom side, said bottom side of said platform having at least three leg brackets;
a seat shaft connected to said top side of said platform;
a seat connected to said seat shaft;
a slide shaft connected to said bottom side of said platform, said slide shaft having a slide which is moveable along at least a portion of said slide shaft, and said slide shaft having at least three slide brackets;
at least three legs having a top end and bottom end, said top end of said each at least three legs being hingedly attached to one of each at least three leg brackets; and
at least three leg braces wherein each leg braces is hingedly attached to one of each at least three slide brackets and one each at least three leg brackets.

8. The portable hunting and fishing stand of claim 7, further comprising one or more fishing holders detachably insertable into said platform.

9. The portable hunting and fishing stand of claim 7, wherein one or more of the at least three legs comprises one or more affixed foot steps.

10. The portable hunting and fishing stand of claim 7, further comprising a seat plate connected between said seat and said seat stand allowing pivotal movement of said seat.

11. The portable hunting and fishing stand of claim 7, further comprising one or more foot pads having a mounting sleeve, said foot pads being detachably connected to said bottom end of said at least three legs.

12. The portable hunting and fishing stand of claim 7, comprising one or more foot pads having one or more fluid passage ways providing fluid communication with water near the outer-upper surface of said foot pads with a concave bottom cavity.

13. A portable hunting and fishing stand comprising:
a platform having a top side and bottom side, said bottom side of said platform having at least three leg brackets;
a seat shaft connected to said top side of said platform;
a seat connected to said seat shaft;
a slide shaft connected to said bottom side of said platform, said slide shaft having a slide which is moveable along at least a portion of said slide shaft, and said slide shaft having at least three slide brackets;
at least three legs having a top end and bottom end, said top end of said each at least three legs being hingedly attached to one of each at least three leg brackets, wherein one or more of the at least three legs comprises one or more affixed foot steps;
at least three leg braces wherein each leg braces is hingedly attached to one of each at least three slide brackets and one of each at least three leg brackets; and
one or more foot pads having a mounting sleeve, connected to said bottom end of said at least three legs.
